(19) United States
(12) Patent Application Publication
(10) Pub. No.: US 2015/0015582 A1
(43) Pub. Date: Jan. 15, 2015

(54) METHOD AND SYSTEM FOR 2D-3D IMAGE REGISTRATION

(71) Applicants: Markus Kaiser, Forchheim (DE); Matthias John, Nurnberg (DE)

(72) Inventors: Markus Kaiser, Forchheim (DE); Matthias John, Nurnberg (DE)

(21) Appl. No.: 13/941,815

(22) Filed: Jul. 15, 2013

(51) Int. Cl. G06T 3/00; G06T 17/20

(52) U.S. Cl. CPC G06T 3/0068; G06T 17/20
USPC 345/427

(57) ABSTRACT

A method of 2D-3D image registration is presented. The method includes accessing a two dimensional image of a subject having an object therein, accessing a three dimensional image data of the subject with the object f, generating a plurality of mesh models from the three dimensional image data, wherein the plurality of mesh models comprise a first mesh model having a first attenuation coefficient and a second mesh model having a second attenuation coefficient, rendering the first mesh model and the second mesh model with a projection geometry of the two dimensional image to obtain a resultant image, iteratively comparing the resultant image with the two dimensional image using a similarity measure, and registering the two dimensional image with the resultant image.

### RELATED FIELD

Embodiments of the present disclosure relate to a system and method for 2D-3D image registration.

### BACKGROUND

More and more procedures in the field of structural heart disease become minimally invasive and catheter-based. This includes for instance trans-catheter aortic valve implantation, trans-catheter mitral valve repair, closure of atrial septal defects, paravalvular leak closure and left atrial appendage occlusion. The drivers for this trend from open-heart surgery to trans-catheter procedures are the availability of new catheter devices and the intra-procedural imaging.

Usually these procedures are performed under fluoroscopic X-ray and trans-esophageal echo (TEE). Intra-operatively these modalities are mainly used independently of each other. X-ray imaging is performed by the cardiologist or surgeon at the left or right side of the patient whereas ultrasound imaging is performed by the anesthesiologist at the head side of the patient. An image fusion of both systems could yield a better mutual understanding of the image contents and potentially even allow new kinds of procedures. The images move relatively to each other because the position of the imaging devices is changed by the operator, as well as because of patient, heart and breathing motion. Therefore, there is a demand of an almost real-time update to synchronize the relative position of both images.

Several approaches have been published for the fusion of ultrasound images in clinical procedures. However, only few of them discuss a direct registration of the images, which is difficult because of the limited field of view of ultrasound and the different image characteristics, in particular in the case of ultrasound fusion with fluoroscopic X-ray images. Therefore, indirect registration approaches were suggested, for example the use of an electromagnetic tracking sensor in the tip of the ultrasound transducer to track the ultrasound probe relatively to a registered X-ray detector.

However, this requires a modified ultrasound transducer and a set-up of the system before or during the clinical procedures. A direct method for a registration of a TEE probe with X-ray is currently known in the art. The method autonomously detects the probe position by combining discriminative learning techniques with a fast binary template library.

A well evaluated direct approach for the fusion of ultrasound with fluoroscopic X-ray was suggested in which a TEE probe is detected in the X-ray image and thereby derives the 3D position of the TEE probe relatively to the X-ray detector, which inherently provides a registration of the ultrasound image to the X-ray image. To estimate the 3D position, a model of the TEE probe is registered to the X-ray image via a 2D-3D registration algorithm. Here a 3D position of the probe is iteratively adapted using Powell's optimization method until the gradient differences measure of the projected probe model image and the X-ray image shows a high similarity. The method does not need additional modifications of the TEE probe and no specific set-up of the system for each procedure. The registration algorithm works well if the initial position for the 2D-3D registration is quite close to the correct position. Its main limitation is the runtime of a registration step which currently does not allow interactive registration updates for the image fusion.

It is therefore desirable to provide a new method and system to accelerate the generation of digital reconstructed radiographs (DRR) which is the most time consuming part of the overall process, in the 2D-3D registration.

### SUMMARY

In accordance with one aspect of the present technique, a method of 2D-3D image registration is provided. The method includes accessing a two dimensional image of a subject having an object therein, accessing a three dimensional image data of the subject with the object f, generating a plurality of mesh models from the three dimensional image data, wherein the plurality of mesh models comprise a first mesh model having a first attenuation coefficient and a second mesh model having a second attenuation coefficient, rendering the first mesh model and the second mesh model with a projection geometry of the two dimensional image to obtain a resultant image, iteratively comparing the resultant image with the two dimensional image using a similarity measure, and registering the two dimensional image with the resultant image.

In accordance with another aspect of the present technique, a system for 2D-3D registration is provided. The system includes a processor configured to access a two dimensional image of a subject having an object therein, access a three dimensional image data of the subject with the object, generate a plurality of mesh models from the three dimensional image data, wherein the plurality of mesh models comprise a first mesh model having a first attenuation coefficient and a second mesh model having a second attenuation coefficient from the three dimensional image data, render the first mesh model and the second mesh model with a projection geometry of the two dimensional image to obtain a resultant image, iteratively compare the resultant image with the two dimensional image using a similarity measure, and register the two dimensional image with the resultant image

In accordance with yet another aspect of the present technique, a non-transitory computer readable medium is provided. The non-transitory computer readable medium includes instruction that, when executed by the processor, causes the processor to perform the method of 2D-3D registration, the method includes accessing a two dimensional image of a subject having an object therein, accessing a three dimensional image data of the subject with the object f, generating a plurality of mesh models from the three dimensional image data, wherein the plurality of mesh models comprise a first mesh model having a first attenuation coefficient and a second mesh model having a second attenuation coefficient, rendering the first mesh model and the second mesh model with a projection geometry of the two dimensional image to obtain a resultant image, iteratively comparing the resultant image with the two dimensional image using a similarity measure, and registering the two dimensional image with the resultant image.

### BRIEF DESCRIPTION OF THE DRAWINGS

The present disclosure is further described hereinafter with reference to illustrated embodiments shown in the accompanying drawings, in which:

FIG. 1 is a flowchart illustrating an exemplary method of generating a two-dimensional image from a three-dimensional image data;

FIG. 2 is a flowchart illustrating the method of 2D-3D image registration;

FIG. 3 illustrates an exemplary system for 2D-3D image registration;

FIG. 4 shows an image depicting an exemplary mesh rendering from a three-dimensional image data;

FIG. 5 shows a resultant image obtained using mesh based rendering;

FIG. 6 shows a vertical gradient image of the resultant image of FIG. 5; and

FIG. 7 shows a horizontal gradient image of the resultant image of FIG. 5, in accordance with aspects of the present technique.

### DETAILED DESCRIPTION

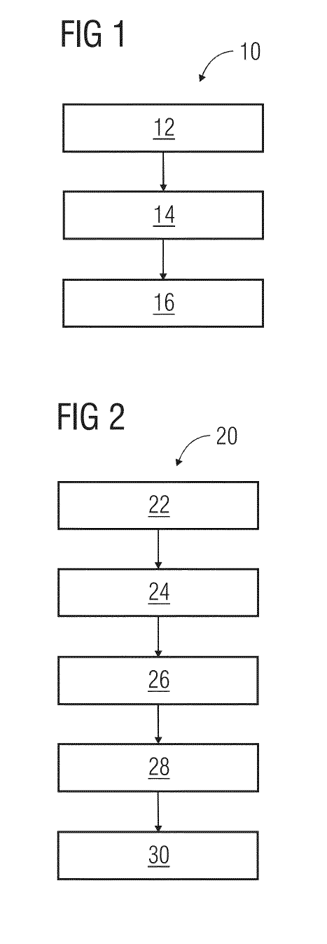

FIG. 1 is a flowchart depicting a method 10 for generating a two-dimensional image from a three-dimensional image data. The three-dimensional image data may be acquired using an imaging modality, such as a Computed Tomgraphy (CT) system which may include a C-arm CT, a CT or a micro-CT system, a magnetic resonance imaging (MRI) system, Positron emission tomography (PET), SPECT and so forth.

A CT system is used to scan a subject and generate a three dimensional image data to achieve the exemplary method. The CT system generates a three-dimensional volume of data of the subject, as at step 12.

At step 14, at least one mesh model is created from the three dimensional image data. In the present embodiment, a first mesh model and a second mesh model are created from the three-dimensional data. The first mesh model has a first attenuation coefficient and the second mesh model has a second attenuation coefficient. The first mesh model and the second mesh model are triangular meshes created from the three dimensional data. Alternatively, the mesh model may be a polygonal mesh created from the three dimensional data.

It may be noted that although two mesh models are generated as mentioned hereinabove, the technique also includes generating one or more mesh models, for example n number of mesh models may be generated from the three-dimensional image data.

In accordance with aspects of the present technique, the first mesh model and the second mesh model are generated using an algorithm, such as the isosurface extraction algorithm.

In an alternate embodiment, the meshes may be generated from the three dimensional image data which may be generated using a Computer aided Design (CAD) model, and may be directly used.

At step 16, the first mesh model and the second mesh model are rendered with projection geometry of a previously acquired two-dimensional image, such as an X-ray image.

In accordance with aspects of the present technique, the two-dimensional image or X-ray image includes one or more parameters such as but not limited to translational parameters. The first mesh model and the second mesh model are rendered with the X-ray image using one or more parameters to obtain a two-dimensional image.

It may be noted that the two-dimensional image thus obtained are referred to as Digitally Reconstructed Radiograph (DRR) image. DRRs are artificial two-dimensional image generated by aligning three-dimensional image data with one or more portal images, which in the present embodiment are X-ray images.

Referring now to FIG. 2, a flowchart depicting an exemplary method 20 of 2D-3D image registration is depicted. The method involves acquiring a two dimensional image of a subject having an object therein from a first modality, as at step 22. The two-dimensional image of the subject which is typically a patient, is a fluoroscopic X-ray image is acquired using an X-ray imaging system. The object which is typically a trans-esophaegal echo (TEE) probe is inserted inside the body of the patient.

Several medical procedures such as trans-cathetar aortic valve implantation, trans-catheter mitral valve repair, etc are performed using fluoroscopic X-ray and TEE. To determine an exact position of the object, which is the TEE probe, a 3-D image data is acquired using a C-arm CT system, as in the presently contemplated configuration. The 3D image data is typically a 3D volume of the TEE probe recorded by the C-arm CT with a resolution of 512³ voxels, as an example.

At step 24, a first mesh model T_{c} and a second mesh model T_{b} are generated from the 3D image data. The first mesh model Tₐ has a first attenuation coefficient and the second mesh model T_{b} has a second attenuation coefficient. The first attenuation coefficient represents structures in the 3D image data having high contrast, and the second attenuation coefficient represents structures in the 3D image data with low contrast. It may be noted that the first mesh model represented structures, such as for example the metal parts of the TEE probe, the second mesh model represented structures, such as for example the plastic parts like covering hull of the TEE probe.

At step 26, the first mesh model and the second mesh model are rendered with a projection geometry of the two dimensional fluoroscopic X-ray image to obtain a resultant image. The resultant image is a Digitally Reconstructed Radiograph (DRR) image which is obtained by rendering the two mesh models with the acquired fluoroscopic X-ray image of the subject having the TEE probe therein.

It may be noted that the two mesh models are rendered using the one or more parameters, such as translational parameters and rotation parameters to generate the resultant image which is the DRR image.

More particularly, the DRR is generated using the projection geometry of the two dimensional fluoroscopic X-ray image. The translational parameter and the rotation parameters are used to change the position and rotation of the TEE probe in a 3D coordinate system and therefore within the DRR image.

At step 28, the resultant image is iteratively compared with the two-dimensional image, which is the fluoroscopic X-ray image using a similarity measure. Similarity measure is used to assess an actual similarity of the two images being compared. To determine the best alignment of the two images, a transformation of the first image onto the second image is a critical issue, which is determined using a similarity measure. Similarity measures are generally divided into two classes namely feature-based and intensity-based.

A similarity measure such as for example Sum of squared differences, Sum of absolute differences, Variance of differences, Normalized cross-correlation, Normalized mutual information, Pattern intensity, Gradient correlation, Gradient difference may be used to compare the two images.

In the presently contemplated configuration, the Gradient correlation (GC) similarity measure is used to compute a horizontal and vertical gradient of the X-ray image and the DRR images and thereafter a Normalized cross Correlation (NCC) between the resulting vertical and horizontal gradient images is calculated. The GC is defined by the following equation:

GC(Iₐ,I_{b})=NCC(Gₓ(Iₐ),Gₓ(I_{b}))/2+NCC(G_{y}(Iₐ),G_{y}(I_{b}))/2 (1)

Where: Gₓ is the horizontal gradient image for the X-ray image (Iₐ) and DRR image (I_{b})
G_{y} is the vertical gradient image for the X-ray image (Iₐ) and DRR image (I_{b})
   NCC may be defined according to the following equation:

$$NCC ( \text{?} , \text{?} ) = \frac{\text{?}}{\text{?}} = \frac{\text{?}}{\sqrt{\text{?}} , \sqrt{\text{?}}} \\ \text{?} \text{indicates text missing or illegible when filed} \qquad ( 2 )$$

Where: σ is the standard deviation of I
Ī is the mean value of I

In accordance with the aspects of the present technique, since the expected value of a gradient image is 0, the computation time of NCC may be shortened to increase the performance of similarity measure evaluation.

Subsequently, at step 30 the resultant image with similarity which is obtained at previous step, is transformed using the translational parameters (tₓ, t_{y}, t_{z},) and rotation parameters (Rₓ, R_{y}, R_{z},) to determine the exact position of the TEE probe in the subject. The transformation results in the highest similarity. In accordance with an aspect of the present technique, an optimizer, such as but not limited to “Powell-Brent” optimizer may be employed for achieving the transformation.

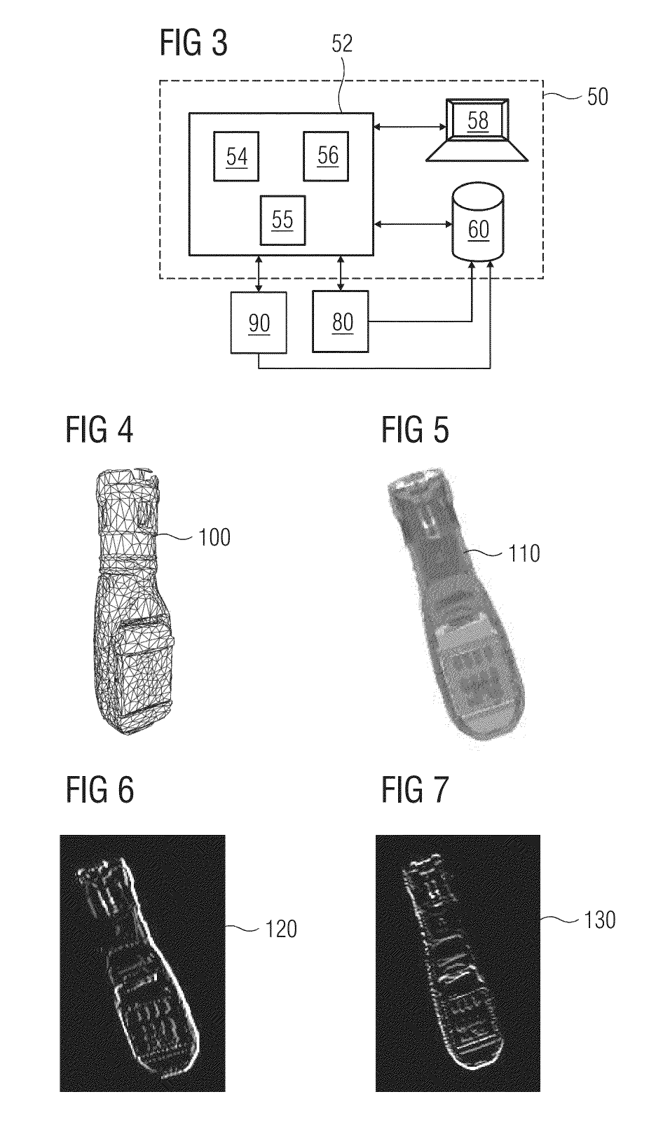

FIG. 3 is a schematic diagram depicting an exemplary system 50 for 2D-3D registration, in accordance with aspects of the present technique. The system 50 is a computer with software applications running on it. The system 50 is connected to an imaging system capable of acquiring a three-dimensional image, such as a CT scanner 80 that includes a bed on which a subject (not shown) such as a patient lies. The subject is driven into the scanner 80 for acquiring three dimensional images. More particularly, the system 50 includes a processor 52 configured to access a plurality of CT images of the subject with different acquisition parameters acquired by the CT scanner 80. It may be noted that the system 50 may be a standalone computer with software applications running on it. Alternatively, the system 50 may be an integral part of the CT scanner 80.

Furthermore, the system 50 is connected to a fluoroscopic X-ray imaging system 90 for acquiring two dimensional image of the subject. The two dimensional image is a fluoroscopic X-ray image of the subject with an object such as the TEE probe therein.

The processor 52 is configured to access the two-dimensional X-ray images acquired by the X-ray imaging system 90. A data repository 60 may be connected to the CT scanner 80 to store three dimensional CT image data. The data repository 60 may be also connected to the X-ray system 90 to store the two-dimensional X-ray image data. This data may be accessed by the processor 52 of the system for further processing. The system 50 includes a display unit 58 to display a registered image of the subject. Alternatively, the image data may also be accessed from a picture archiving and communication system (PACS). In such an embodiment the PACS might be coupled to a remote system such as such as a radiology department information system (RIS), hospital information system (HIS) or to an internal or external network, so that image data may be accessed from different locations.

In an alternate embodiment, a computer aided design (CAD) model may be used by the system, without employing a 3D scanner for the three dimensional image data.

The processor 52 includes a mesh generation module 54, a similarity module 55 and a registration module 56. The mesh generation module 54 generates a first mesh model and a second mesh model having a first attenuation coefficient and a second attenuation coefficient respectively, from the three-dimensional image data acquired by the CT scanner 80.

Additionally, the processor 52 is configured to render the first mesh model and the second mesh model with a projection geometry of the two dimensional image, which is the X-ray image in the present embodiment to obtain a resultant image. In the presently contemplated configuration, OpenGL was used to render the first mesh model and the second mesh model. Furthermore, the processor 52 is also configured to pre-process the first mesh model and the second mesh model wherein artifacts in the mesh models are removed.

The similarity module 55 in the processor 52 is configured to iteratively compare the resultant image with the two dimensional image using a similarity measure. As previously noted, the gradient correlation (GC) is the similarity measure used in the presently contemplated configuration, as described with reference to FIG. 2.

The processor 52 further includes a registration module 56 for registering the resultant image with the two-dimensional X-ray image. The registered image is displayed in the display unit 58.

FIG. 4 illustrates an image 100 depicting an exemplary mesh rendering from the three-dimensional image data which is the image data of a TEE probe acquired using the C-arm CT imaging system. As previously noted, the first mesh model and the second mesh model which are typically triangular meshes, are generated from the three-dimensional image data. The meshes are generated using an isosurface extraction algorithm. The first mesh model and second mesh model are rendered with projection geometry of the two-dimensional X-ray image to generate a resultant image.

FIG. 5 illustrates a resultant image 110 obtained using mesh based rendering. The resultant image is a DRR of the TEE probe generated from the first mesh model and the second mesh model after rendering.

FIG. 6 illustrates a vertical gradient image 120 of the resultant image 110 of FIG. 5 and FIG. 7 illustrates a horizontal gradient image 130 of the resultant image 110 of FIG. 5.

The exemplary method and system as disclosed hereinabove has a significantly less implementation time of about 1.0 millisecond for the generation of DRR images and calculating the similarity measure. The method provides a rendered DRR image and calculates the similarity between the DRR and the X-ray image with less runtime than the presently existing methods. Additionally, the present method and system provides flexibility le to be used with any optimization method in the 2D-3D registration pipeline to finally compute a fusion of the images.

It should be noted that the term “comprising” does not exclude other elements or steps and the use of articles “a” or “an” does not exclude a plurality.

Although the disclosure has been described with reference to specific embodiments, this description is not meant to be construed in a limiting sense. Various modifications of the disclosed embodiments, as well as alternate embodiments, will become apparent to persons skilled in the art upon reference to the description of the invention. It is therefore contemplated that such modifications can be made without departing from the embodiments of the present disclosure as defined.

1. A method of 2D-3D image registration , the method comprising:
accessing a two dimensional image of a subject having an object therein;
accessing a three dimensional image data of the subject with the object;
generating a plurality of mesh models from the three dimensional image data, wherein the plurality of mesh models comprise a first mesh model having a first attenuation coefficient and a second mesh model having a second attenuation coefficient;
rendering the first mesh model and the second mesh model with a projection geometry of the two dimensional image to obtain a resultant image;
iteratively comparing the resultant image with the two dimensional image using a similarity measure; and
registering the two dimensional image with the resultant image.

2. The method according to claim 1,
wherein the two dimensional image is a fluoroscopic X-ray image.

3. The method according to claim 1,
wherein the three dimensional image data is acquired using a three dimensional imaging modality, and
wherein the three dimensional imaging modality comprises a CT, C-arm CT, MR.

4. The method according to claim 1,
wherein the three dimensional image data is a CAD model.

5. The method according to claim 1,
wherein the first attenuation coefficient of the first mesh model is higher than the second attenuation coefficient of the second mesh model.

6. The method according to claim 1,
wherein the first mesh model and the second mesh model comprise a plurality of triangular meshes.

7. The method according to claim 6,
wherein the triangular meshes are generated using an isosurface extraction algorithm.

8. The method according to claim 1, further comprising:
preprocessing the first mesh model and the second mesh model to remove artifacts.

9. The method according to claim 1,
wherein the rendering of the first mesh model and the second mesh model is done using alpha blending.

10. The method according to claim 1,
wherein the similarity measure comprises gradient correlation similarity measure.

11. The method according to claim 10,
wherein a horizontal gradient resultant image is compared with a horizontal gradient of the two-dimensional image and a vertical gradient resultant image is compared with a vertical gradient of the two dimensional image.

12. A system for 2D-3D registration, the system comprising:
a processor configured to
access a two dimensional image of a subject having an object therein,
access a three dimensional image data of the subject with the object,
generate a plurality of mesh models from the three dimensional image data, wherein the plurality of mesh models comprise a first mesh model having a first attenuation coefficient and a second mesh model having a second attenuation coefficient,
render the first mesh model and the second mesh model with a projection geometry of the two dimensional image to obtain a resultant image,
iteratively compare the resultant image with the two dimensional image using a similarity measure, and
register the two dimensional image with the resultant image.

13. The system according to claim 16,
wherein the processor comprises a mesh generation module for generating the first mesh model and the second mesh model.

14. The system according to claim 16, further comprising
a display unit configured to display the resultant image and the two dimensional image.

15. The system according to claim 16,
wherein the processor is further configured to preprocess the first mesh model and the second mesh model.

16. The system according to claim 16,
wherein the processor is configured for parallel processing of rendering the mesh models together with the computation of similarity measure.

17. A non-transitory computer readable medium comprising computer readable instructions that, when executed by a processor, causes the processor to perform a method of 2D-3D image registration, the method comprising:
accessing a two dimensional image of a subject having an object therein,
accessing a three dimensional image data of the subject with the object,
generating a plurality of mesh models from the three dimensional image data, wherein the plurality of mesh models comprise a first mesh model having a first attenuation coefficient and a second mesh model having a second attenuation coefficient,
rendering the first mesh model and the second mesh model with a projection geometry of the two dimensional image to obtain a resultant image,
iteratively comparing the resultant image with the two dimensional image using a similarity measure, and
registering the two dimensional image with the resultant image.

18. The non-transitory computer readable medium according to claim 17,
wherein the three dimensional image data is acquired using a three dimensional imaging modality, wherein the three dimensional imaging modality comprises a CT, C-arm CT, MR.

19. The non-transitory computer readable medium according to claim 17,
wherein the three dimensional image data is a CAD model.

20. The non-transitory computer readable medium according to claim 17,
wherein the first mesh model and the second mesh model comprise a plurality of triangular meshes.
